(19) United States
(12) Patent Application Publication
(10) Pub. No.: US 2007/0159454 A1
(43) Pub. Date: Jul. 12, 2007

(54) CONTROL PANEL FOR AN ELECTRONIC DEVICE

(76) Inventors: Wendeline Rodriguez, Grand Haven, MI (US); Darryl C. Bodine, St. Joseph, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 11/275,487

(22) Filed: Jan. 9, 2006

(51) Int. Cl. G09G 5/00

(52) U.S. Cl. 345/156

(57) ABSTRACT

A control panel for an electronic device includes a sensor array capable of sensing a location along the sensor array of a finger proximate to the sensor array. A channel on the control panel defines a guide path in register with at least a portion of the sensor array and is sized to receive a portion of a finger. The channel is operable to guide a finger of a user along the sensor array, and the sensed location of the finger along the sensor array can be used as an indication of an input selection by the user.

### BACKGROUND OF THE INVENTION

1. Field of the Invention

The invention relates to a control panel for an electronic device.

2. Description of the Related Art

Electronic devices, such as household appliances, including dishwashers, washing machines, clothes washers, and clothes dryers, typically have a controller that operatively communicates with the functional components of the electronic device to implement an operational mode of the electronic device. Such electronic devices also include a control panel coupled to the controller so that the user can communicate with the controller. For example, the user can input information, such as a desired operational mode or parameters/options for a desired operational mode, through the control panel, and the controller can send output information, such as a status of an operational mode, to the control panel for display to the user. Many types of control panels with various types of knobs, buttons, display screens, and touch pads have been developed over the years. However, some existing control panels are difficult to clean because of the many crevices around the knobs, buttons, etc. Control panels having touch pads are generally smoother and easier to clean, but they tend to be expensive and cost-prohibitive, especially for lower end electronic devices. Furthermore, some existing control panels are not intuitive or user friendly, which can potentially deter a customer from purchasing a certain electronic device.

### SUMMARY OF THE INVENTION

A control panel for an electronic device according to one embodiment of the invention includes a support panel, a sensor array on the support panel and operable to sense a location along the sensor array of a finger proximate to the sensor array, an outer panel covering the support panel and having a nominal surface, and a channel formed in the outer panel with at least a portion of the channel located below the nominal surface, the channel defining a guide path sized to receive a portion of a finger and in register with at least a portion of the sensor array. The channel is configured to guide a finger of a user along the sensor array, and the sensed location of the finger along the sensor array is used as an indication of an input selection by the user.

### BRIEF DESCRIPTION OF THE DRAWINGS

In the drawings:

FIG. 1 is a schematic view of an electronic device with a control panel according to one embodiment of the invention.

FIG. 2 is a front view of a dishwasher with the control panel of FIG. 1 according to a first embodiment of the invention.

FIG. 3 is an enlarged view of the control panel of FIG. 2.

FIG. 4 is a front exploded view of the control panel of FIG. 2.

FIG. 4A is an enlarged view of the area labeled 4A in FIG. 4.

FIG. 5 is a sectional view taken along line 5-5 of FIG. 3.

FIG. 6 is a sectional view taken along line 6-6 of FIG. 3.

FIG. 7 is a rear exploded view of the control panel of FIG. 2.

FIG. 8A is a front view of the control panel similar to FIG. 2 with selected dimensions of various features identified.

FIG. 8B is a view taken along line 8B-8B of FIG. 8A showing an outer profile of the control panel.

FIG. 8C is a view taken along line 8C-8C of FIG. 8A showing an outer profile of the control panel.

FIG. 9 is a rear perspective view of the control panel of FIG. 2.

FIG. 10 is a front view of the control panel similar to FIG. 3, with a finger moving along a channel of an operation mode selector.

FIG. 11A is a view similar to FIG. 8B of a control panel according to a second embodiment of the invention.

FIG. 11B is a view similar to FIG. 8B of a control panel according to a third embodiment of the invention.

### DESCRIPTION OF EMBODIMENTS OF THE INVENTION

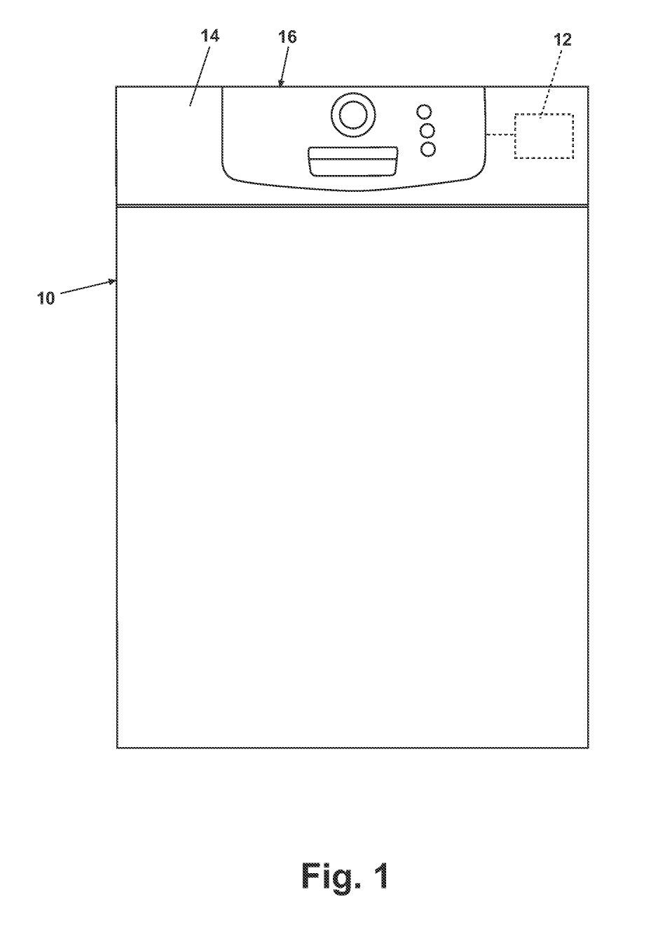

Referring now to the figures, FIG. 1 is a schematic view of an electronic device with a control panel 16 according to one embodiment of the invention. The electronic device can be a household appliance 10 according to one embodiment of the invention and includes a controller 12 and a console 14 with the control panel 16 operatively coupled to the controller 12. The controller 12 can be a proportional-integral-derivative (PID) controller or any other suitable controller, as is well-known in the household appliance art. The controller 12 can be operably coupled with functional components of the household appliance 10, which vary according to the type of household appliance, to implement a mode of operation for the household appliance 10.

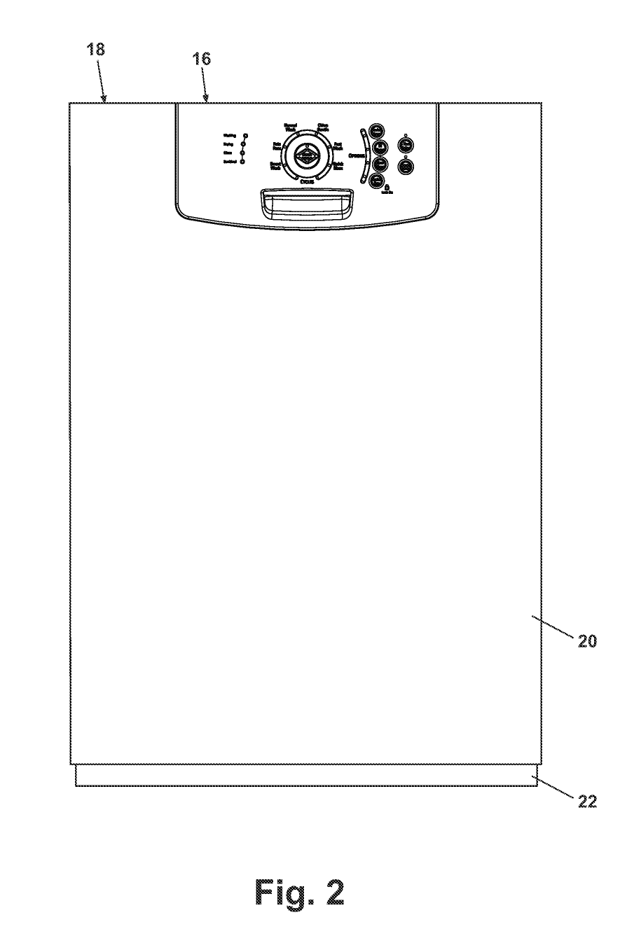

The household appliance 10 can be any suitable household appliance, such as a dishwasher. FIG. 2 is a front view of a dishwasher 18 with the control panel 16 according to a first embodiment of the invention. For illustrative purposes, the control panel 16 is hereinafter shown and described with respect to the household dishwasher 18. It is to be understood that the use of the control panel 16 with the dishwasher 18 is by way of illustration and not limitation, and the control panel 16 can be employed with any suitable household appliance or other electronic device.

Examples of other household appliances include, but are not limited to, a refrigerator, a freezer, an ice maker, a compactor, an air conditioner, an oven, a microwave, a stove, a clothes washer, and a clothes dryer. Examples of other suitable electronic devices include, but are not limited to, audio equipment, such as stereos, radios, CD players, digital audio players, and the like, video equipment, such as televisions, camcorders, DVD players, digital video players, and the like, and thermostats.

With continued reference to FIG. 2, the dishwasher 18 includes a door 20 movably mounted to a cabinet 22 to selectively close an open-face wash chamber (not shown) defined by the cabinet 22 for holding a dish load, as is well known in the dishwasher art. The control panel 16 is illustrated in FIG. 2 as mounted to an upper portion of the door 20 so that the user can easily access the control panel 16, but it is within the scope of the invention to locate the control panel 16 in any suitable location on the dishwasher 18.

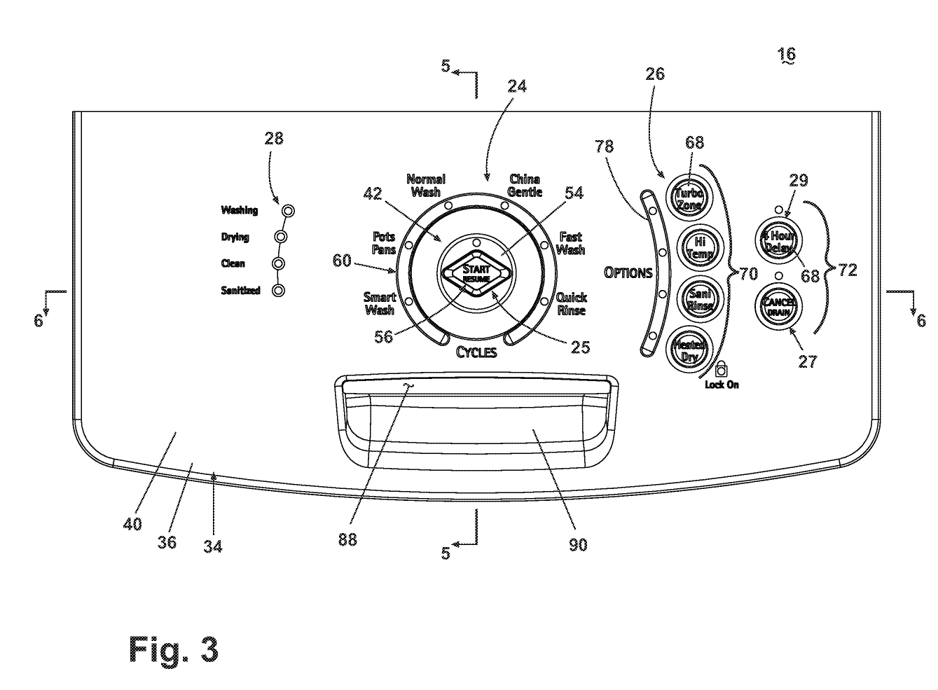

FIG. 3 is an enlarged view of the control panel 16 of FIG. 2. The control panel 16 includes a mode selector 24, an option selector 26, and a mode status indicator 28. The user selects a desired operational mode through the mode selector 24 and selects or deselects options for the selected operational mode through the option selector 26. Exemplary operational modes shown in FIG. 3 include Smart Wash, Pots/Pans, Normal Wash, China Gentle, Fast Wash, and Quick Rinse. During the Smart Wash mode, the cleaning level and cycle time can be automatically selected based on a size of the dish load and a soil level of the dish load. The Pots/Pans mode can be utilized for hard-to-clean and heavily soiled pots, pans, and other dishes, the Normal Wash mode can be employed for dish loads with a normal amount of food soil, and the China Gentle mode can be suited for lightly soiled items or china and crystal. The Fast Wash mode quickly washes dish loads that are pre-rinsed, and the Quick Rinse mode rinses dish loads that will not be washed immediately. The selected operational mode can be started or, in the case where a running operational mode has been interrupted, resumed through a mode activation selector 25, canceled through a mode cancellation selector 27, and delayed through a mode delay selector 29.

Exemplary options shown in FIG. 3 for the exemplary operational modes are Turbo Zone, Hi-Temp, Sani-Rinse, and Heated Dry. The Turbo Zone option can involve high pressure washing to handle extra dirty dish loads, the Hi-Temp option increases the water temperature during wash portions of the cycle, the Sani-Rinse option raises the water temperature in a final rinse portion of the cycle, and the Heated Dry option dries the dish load with heat.

The mode status indicator 28 communicates to the user the status of the selected operational mode. For example, the mode status indicator 28 can include visual indicators to inform the user when the operational mode is at a washing stage or a drying stage, or when the dish load is clean upon completion of the selected operational mode. Additionally, the mode status indicator 28 can communicate to the user when the dish load is sanitized after completion of the selected operational mode with the Sani-Rinse option. The above operational modes and options are provided for illustrative purposes only and are not intended to limit the invention in any manner.

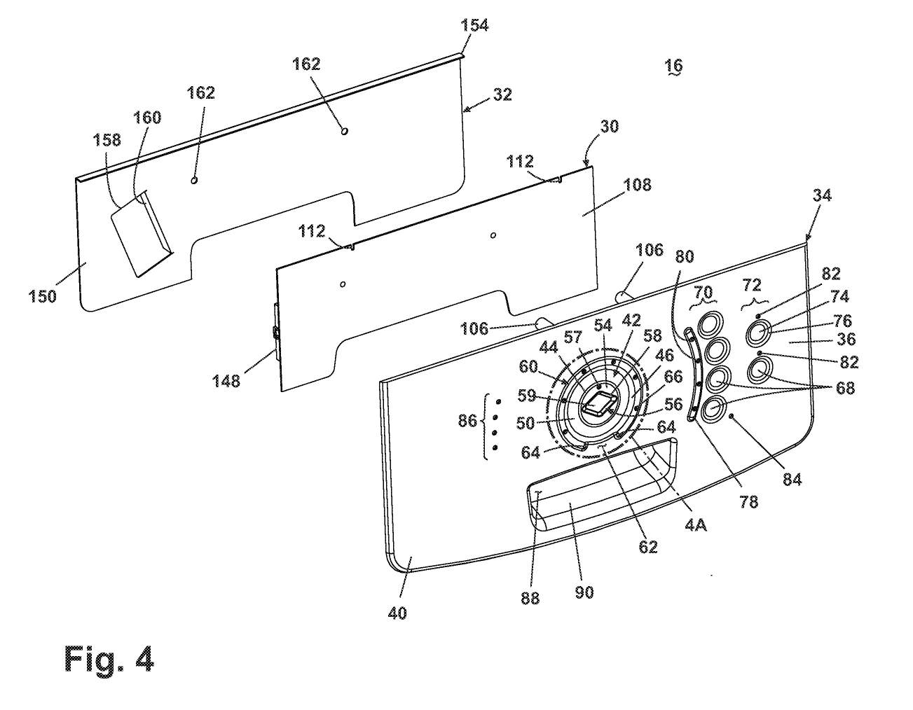

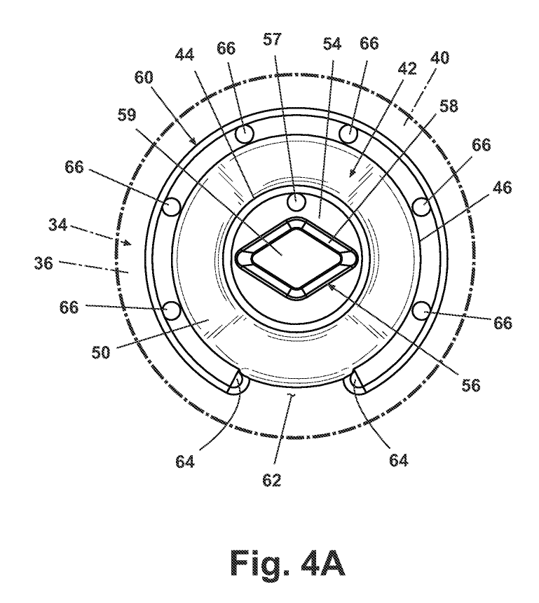

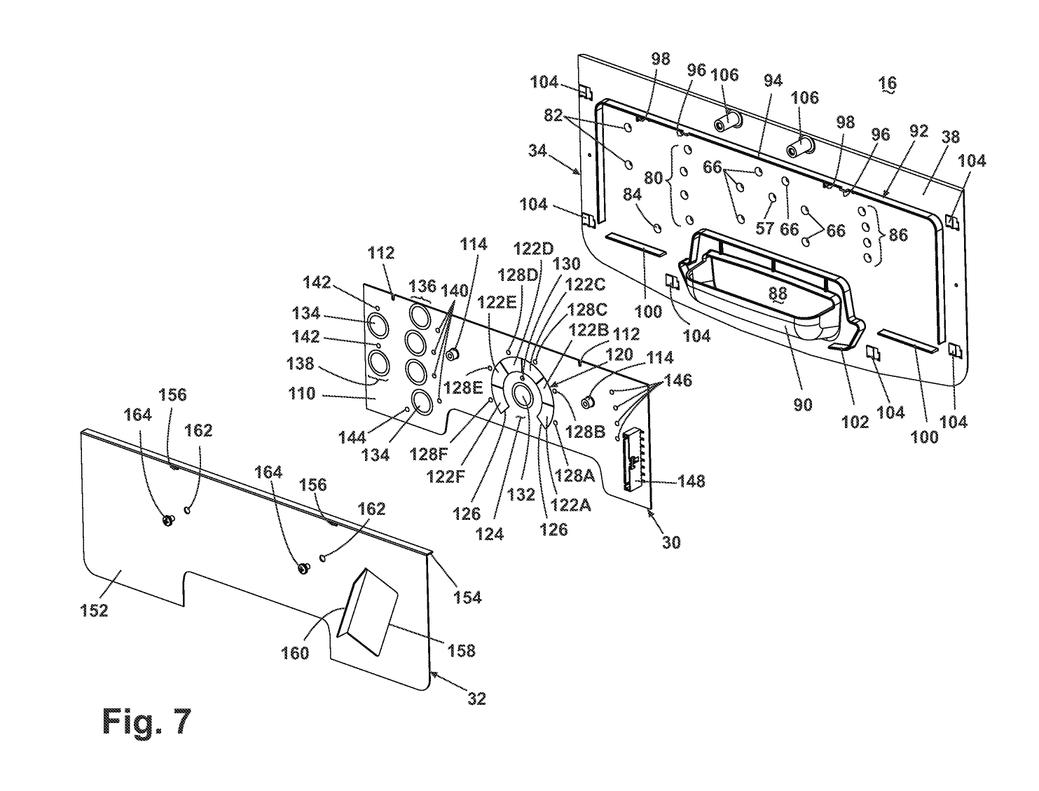

FIG. 4 is a front exploded view of the control panel 16 of FIG. 2. The control panel 16 includes a support panel 30 mounted between an inner panel 32 and an outer panel 34. The outer panel 34, which can be optionally constructed of a polymeric material, such as polyvinyl chloride (PVC), protects the support panel 30 and provides an interface through which the user can communicate with the controller 12. The outer panel 34 has a front or outer side or face 36 and a rear or inner side 38 (FIG. 7). The front side 36 can define a nominal surface 40. The nominal surface 40 can be generally planar, and the outer panel 34 includes several features on the front side 36 that are recessed or raised relative to the nominal surface 40. Thus, the nominal surface 40 can be regarded as a reference surface, and the depth or height of the recessed and raised features can be measured relative to reference surface. Alternatively, the nominal surface can be higher than or lower than the front side 36 of the outer panel 34.

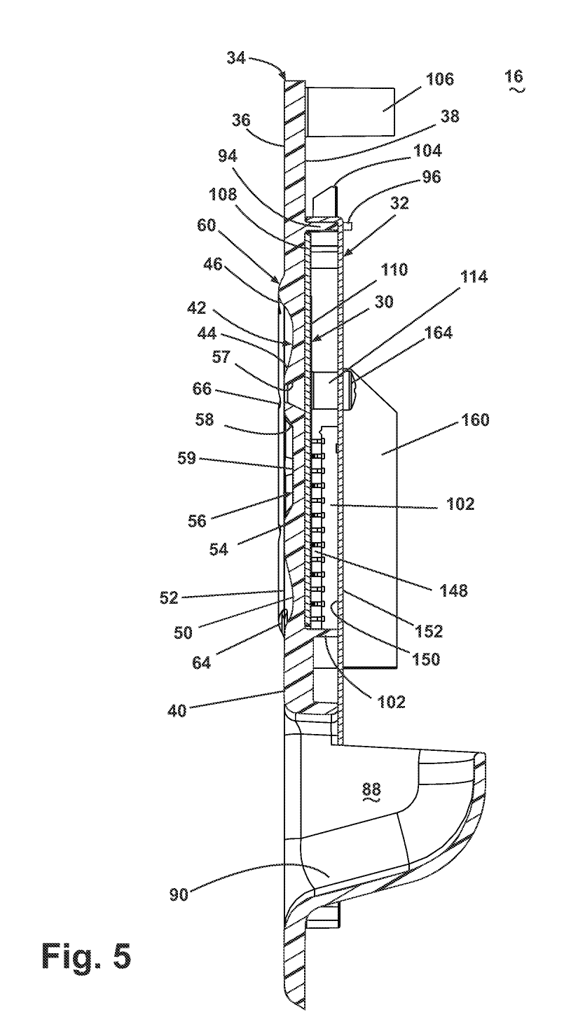

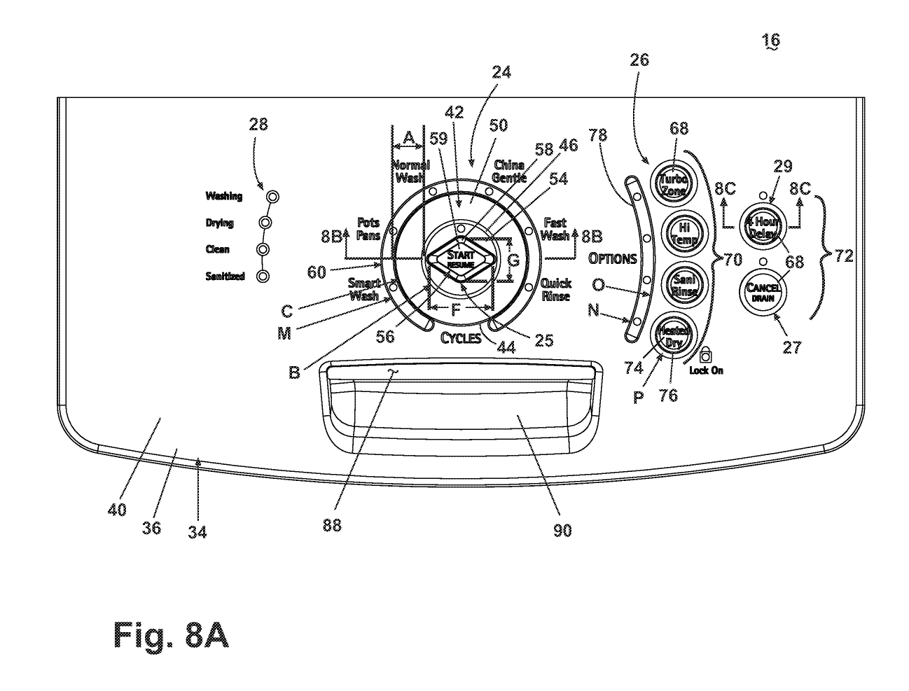

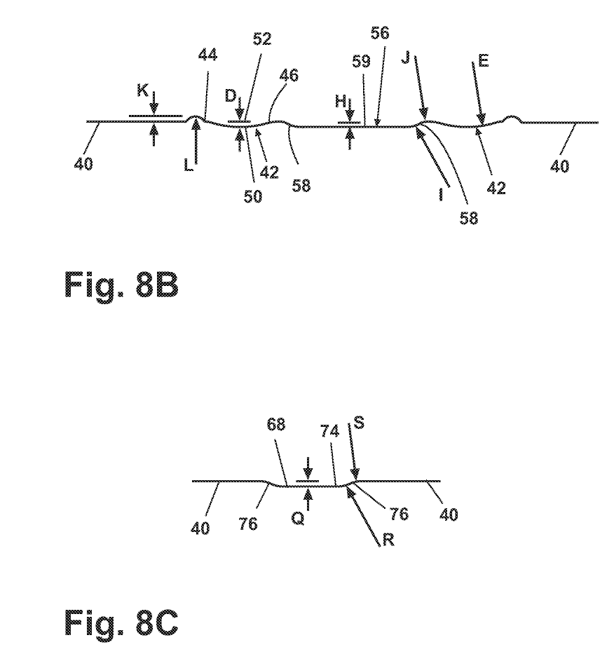

One of the recessed features can be a channel 42, and, according to the illustrated embodiment, the channel 42 can be arcuate and can form a circle. The channel 42 can be sized to receive at least a portion of a human finger, such as a fingertip, so that a user can move the finger along the channel 42. FIG. 4A is an enlarged view of the area labeled 4A in FIG. 4. The channel 42 has a width defined between an inside edge 44 and an outside edge 46. The inside and outside edges 44, 46 can be curved so that the channel 42 is generally U-shaped when viewed in cross-section, as shown in FIG. 5, which is a sectional view taken along line 5-5 of FIG. 3. The channel 42 has a depth that can be measured between a bottom 50 and an open top 52 (see also FIG. 8B) that can be substantially flush with the nominal surface 40. The bottom 50 can be the portion of the channel 42 that is farthest from the nominal surface 40.

Referring back to FIG. 4A, the inside edge 44 of the channel 42 defines a center area 54 that can be generally circular and flush with the nominal surface 40 and, thus, raised relative to the bottom 50 of the channel 42. The center area 54 can include a depression 56, which, according to the illustrated embodiment, can have a diamond shape defined by a periphery 58 and a generally flat bottom 59 recessed to any suitable depth, such as a depth about equal to the depth of the channel 42. The periphery 58 can be angled, inclined, or curved so that the nominal surface 40 in the center area 54 gradually transitions to the depression 56 without forming a sharp ledge between the nominal surface 40 of the center area 54 and the depression 56. The center area 54 can further include an aperture 57 positioned adjacent the depression 56 and extending from the rear side 38 through the front side 36 of the outer panel 34 to transmit light through the outer panel 34.

The outer panel 34 can include a rib 60 raised relative to the nominal surface 40 and disposed adjacent the outside edge 46 of the channel 42. The rib 60 can be arcuate and can at least partially surround the channel 42. According to the illustrated embodiment, the rib 60 may not completely encircle the channel 42 so as to form a gap 62 between its ends 64. Alternatively, the rib 60 can completely encircle the channel 42. A plurality of circumferentially spaced apertures 66 formed in the rib 60 extends from the rear side 38 through the front side 36 of the outer panel 34. Referring again to FIG. 5, the rib 60 can have a curved profile when viewed in cross-section. The channel 42 can smoothly transition directly into the rib 60 at the outside edge 46 of the channel 42. Alternatively, the rib 60 can be spaced from the outside edge 46 of the channel 42.

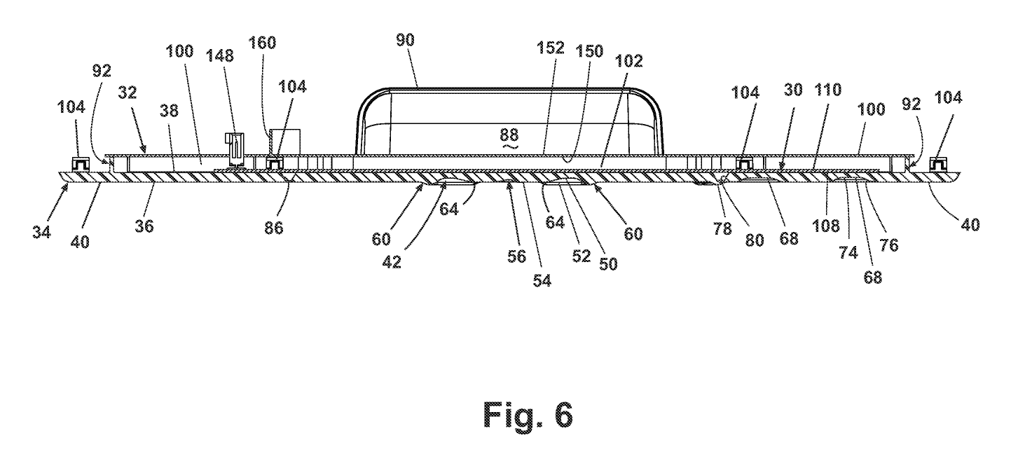

Referring back to FIG. 4, other recessed features of the outer panel 34 include a plurality of depressions 68 spaced from the channel 42. According to the illustrated embodiment, the depressions 68 can be grouped into a first set 70 and a second set 72. The first set 70 includes four circular depressions arranged in an arcuate configuration, and the second set 72 includes two vertically aligned circular depressions. As shown in FIG. 6, which is a sectional view taken along line 6-6 of FIG. 3, the depressions 68 each have a generally flat bottom 74 and a periphery 76 that can be somewhat curved to gradually transition the nominal surface 40 to the bottom 74 (see also FIG. 8B).

Referring back to FIG. 4, the outer panel 34 further includes a rib 78 adjacent to and spaced from the first set 70 of the depressions 68. The rib 78 can be raised above nominal surface 40 and can have an arcuate shape to generally correspond to the arcuate configuration of the first set 70 of the depressions 68. As best viewed in FIG. 6, which is a sectional view taken along line 6-6 of FIG. 3, the rib 78 can have a curved profile, similar to that of the rib 60 adjacent the channel 42. Referring back to FIG. 4, the rib 78 can include a plurality of spaced apertures 80 that extend from the rear side 38 through the front side 36 of the outer panel 34 to transmit light through the outer panel 34. According the illustrated embodiment, the rib 78 has four of the apertures 80, with each of the apertures 80 corresponding to and aligned with one of the four depressions 68 in the first set 70. The outer panel 34 can also include other apertures 82 adjacent to each of the depressions 68 in the second set 72, an aperture 84 in the vicinity of the first set 70, and a group of four apertures 86 spaced from the channel 42 and the depressions 68 and, according to the illustrated embodiment, arranged in an generally arcuate configuration. The location of the apertures 82, 84, 86 can be positioned in any suitable location on the outer panel 34 and are not limited to the locations shown in the figures. For example, the apertures 80, 82 could be positioned in their corresponding depressions 68, such as in the bottom 74 of the depression 68, or the apertures 82 could be disposed in a raised ring that at least partially surrounds their corresponding depressions 68.

The outer panel 34 can further include an elongated opening 88 located below the channel 42 and sized to receive a portion of a hand of the user to facilitate manipulation of the door 20 relative to the cabinet 22. An open-top cup 90 projects rearward from the opening 88 to help guide the hand of the user generally upward as the user inserts the hand through the opening 88 so that the hand of the user is in the most suitable position for manipulation of the door 20. Alternatively, the control panel 16 can include another type of handle to facilitate manipulation of the door 20, or the handle can be located elsewhere on the dishwasher 18.

FIG. 7 is a rear exploded view of the control panel 16 of FIG. 2. The rear side 38 of the outer panel 34 can be generally planar and parallel to the nominal surface 40. A U-shaped projection 92 extends from the rear side 38, and a generally horizontal portion 94 of the U-shaped projection 92 includes pair of lateral tabs 96 that extend farther rearward than the U-shaped projection 92 and a pair of depending tabs 98. A pair of lower projections 100 generally parallel to the horizontal portion 94 of the U-shaped projection 92 can be located at an open, lower end of the U-shaped projection 92 with each of the lower projections 100 disposed on opposite sides of a projection 102 that partially circumscribes the opening 88 and the cup 90. Together, the projections 92, 100, 102 define a frame on the rear side 38 that facilitates alignment and mounting of the support panel 30 to the outer panel 34. The rear side 38 further includes a plurality of mounting tabs 104 and a pair of screw bosses 106 for mounting the control panel 16 to the dishwasher 18.

FIG. 8A is a front view of the control panel 16 of FIG. 2 with selected dimensions of various features identified. FIGS. 8B and 8C are outer profiles of the outer panel 34 taken along lines 8B-8B and 8C-8C of FIG. 8A. Exemplary dimensions for various features of the outer panel 34 shown in FIGS. 8A-8C are listed in Table 1. The views in FIGS. 8B and 8C do not represent a complete cross-section; rather, the lines in these views simply follow the contour of the front side 36 of the outer panel 34. The dimensions listed in Table I are provided for illustrative purposes only and are not intended to limit the invention in any manner.

TABLE I
Exemplary Dimensions for the Control Panel

| Reference | | Dimension |
|---|---|---|
| Letter | Feature | (mm) |
| A | Channel width | 11.5 |
| B | Channel inner diameter | 31.4 |
| C | Channel outer diameter | 54.4 |
| D | Channel depth | 1.0 |
| E | Channel radius of curvature | 17.5 |
| F | Center area depression width | 25.4 |
| G | Center area depression height | 16.0 |
| H | Center area depression depth | 1.0 |
| I | Center area depression radius of curvature | 5.0 |
| | at periphery near depression | |
| J | Center area depression radius of curvature | 2.5 |
| | at periphery near raised area | |
| K | Channel rib height | 1.0 |
| L | Channel rib radius of curvature | 2.0 |
| M | Channel rib outer diameter | 64.0 |
| N | Options rib inner diameter | 148.0 |
| O | Options rib outer diameter | 158.0 |
| P | Options depression diameter | 15.0 |
| Q | Options depression depth | 1.0 |
| R | Options depression radius of curvature | 5.0 |
| | at periphery near depression | |
| S | Options depression radius of curvature | 5.0 |
| | at periphery near nominal surface | |

According to one embodiment, the dimensions for the features of the outer panel 34 can be selected so that the front side 36 is easy to clean and the features are easy to utilize. For example, the recessed features can be deep enough to be discernable to the user and to provide a target location for the user to position an appendage, such as a finger, in the proper areas of the outer panel 34 yet sufficiently shallow so that the user can easily wipe the front side 36 clean without debris collecting in crevices. An exemplary range of depths for the channel 42 is from about 0.1 mm to about 3 mm. Furthermore, the width of the channel 42 can be selected to accommodate a tip of a human finger. The width of the channel 42 listed in Table 1 is about 11.5 mm. Other examples of dimensions for the width of the channel 42 are ranges of about 10 mm to about 15 mm and about 11 mm to about 12 mm.

Referring back to FIG. 7, the support panel 30, which, according to the illustrated embodiment, can be a printed circuit board shaped to fit within the frame defined by the projections 92, 100, 102 on the rear side 38 of the outer panel 34, has a front or outer side 108 (FIG. 4) that faces the outer panel 34 and a rear or inner side 110 opposite the front side 108. The support panel 30 includes pair of slits 112 sized to receive the depending tabs 98 of the outer panel 34. Additionally, a pair of screw bosses 114 extends from the rear side 110 to facilitate mounting the inner panel 32 to the support panel 30, as will be described in more detail below.

With continued reference to FIG. 7, the support panel 30 supports a sensor array 120 having a configuration corresponding to that of the channel 42 of the outer panel 34, and the sensor array 120 and the channel 42 together form the mode selector 24 (FIG. 3). Thus, the channel 42 defines a guide path that guides the user's finger in the channel 42 along the sensor array 120. According to the illustrated embodiment, the sensor array 120 can have an arcuate configuration and can form a gap 124 between its ends 126. The sensor array 120 includes a plurality of sensors 122 (shown as sensors 122A-122E) that can be arranged in portions, and each portion can correspond to one of the operational modes of the appliance. Each of the portions can have more than one sensor 122 or a single, discrete sensor 122. According to the illustrated embodiment, each portion of the sensor array 120 has a single, discrete sensor 122 corresponding to one of the aforementioned operational modes. For example, the sensor array 120 can have six sensors 122A-122F that respectively correspond to the aforementioned Smart Wash, Pots/Pans, Normal Wash, China Gentle, Fast Wash, and Quick Rinse operational modes.

A plurality of indicators 128 (shown as indicators 128A-128E) having a number of indicators equal to the number of the sensors 122 are positioned adjacent the sensor array 120 such that they align with the apertures 66 in the rib 60 adjacent the channel 42 (FIG. 4) on the outer panel 34, and each of the indicators 128 corresponds to one of the sensors 122. According to the illustrated embodiment, the support panel 30 supports six of the indicators 128A-128F that correspond to the six sensors 122A-122F and the aforementioned respective Smart Wash, Pots/Pans, Normal Wash, China Gentle, Fast Wash, and Quick Rinse operational modes. The indicators can be a visual indicator, such as an illumination source. An exemplary suitable illumination source is a light emitting diode (LED) or other well-known sources of light, such as electroluminescence. The support panel 30 can further support an indicator 130 positioned inside the sensor array 120 in alignment with the aperture 57 positioned adjacent the central area depression 56 (FIG. 4). The indicator 130 can be associated with a corresponding sensor 132 that aligns with the center area depression 56, and the sensor 132 and the center area depression 56 form the mode activation selector 25 (FIG. 3).

The support panel 30 can further support a plurality of sensors 134 spaced from the sensor array 120 and arranged in a first set 136 and a second set 138. The first set 136 of the sensors 134 can be configured to correspond to the first set 70 of the depressions 68, and, likewise, the second set 138 of the sensors 134 can be configured to correspond to the second set 72 of the depressions 68 (FIG. 3). Together, the first set 136 of the sensors 134 and the first set 70 of the depressions 68 form the option selector 26. A plurality of indicators 140 can be located adjacent the first set 136, with each of the indicators 140 corresponding to one of the sensors 134 in the first set 136, and can be spaced to align with the apertures 80 in the rib 78 adjacent the first set 70 of the depressions 68 (FIG. 4). One of the sensors 134 in the second set 138 and one of the depressions 68 in the second set 72 can form the mode cancellation selector 27 (FIG. 3), and the other of the sensors 134 in the second set 138 and the other of the depressions 68 in the second set 72 can form the mode delay selector 29 (FIG. 3). Indicators 142 can be positioned adjacent the second set 138 of the sensors 134 and can be spaced to align with the apertures 82 adjacent the second set 72 of the depressions 68 in the outer panel 34 (FIG. 4). Another indicator 144 near the sensors 134 can be positioned to align with the aperture 84 (FIG. 4) in the vicinity of the first set 70 of the depressions 68, and this indicator 144 can be used, for example, to communicate to the user a condition where the controller 12 is locked to prevent usage of the control panel 16, such as by children. The support panel 30 can further support a plurality of indicators 146 that can be spaced from the sensor array 120 and can be arranged in a generally arcuate configuration to align with the apertures 86 (FIG. 4) and form the mode status indicator 28 (FIG. 3).

With continued reference to FIG. 7, the support panel 30 can further support a connector 148 operatively coupled to the sensors 122 of the sensor array 120 and the other sensors 132, 134. The connector 148 can project from the rear side 110 and can receive a plug or other mating member (not shown) of a cable (not shown) that operatively couples the sensors 122, 132, 134 to the controller 12. According to the illustrated embodiment, the connector 148 removably receives the plug.

The sensors 122, 132, 134 on the support panel 30 can be any suitable sensor that can detect the presence of an object, such as a human appendage, in close proximity to the sensor. The sensors can be contact or non-contact sensors. For non-contact sensors, the object need not directly touch the sensor to activate the sensor. Examples of suitable sensors include, but are not limited to, field effect sensors and capacitive sensors. Other exemplary sensors include, but are not limited to, inductive sensors, eddy current, inductive, photoelectric, ultrasonic, or Hall effect sensors. Furthermore, the sensors can function as an electrical switch that can perform any function that can be performed by a mechanical switch. These types of electrical switches are commonly referred to as touch switches. Additionally, the sensors 132, 134 can alternatively be a mechanical switch.

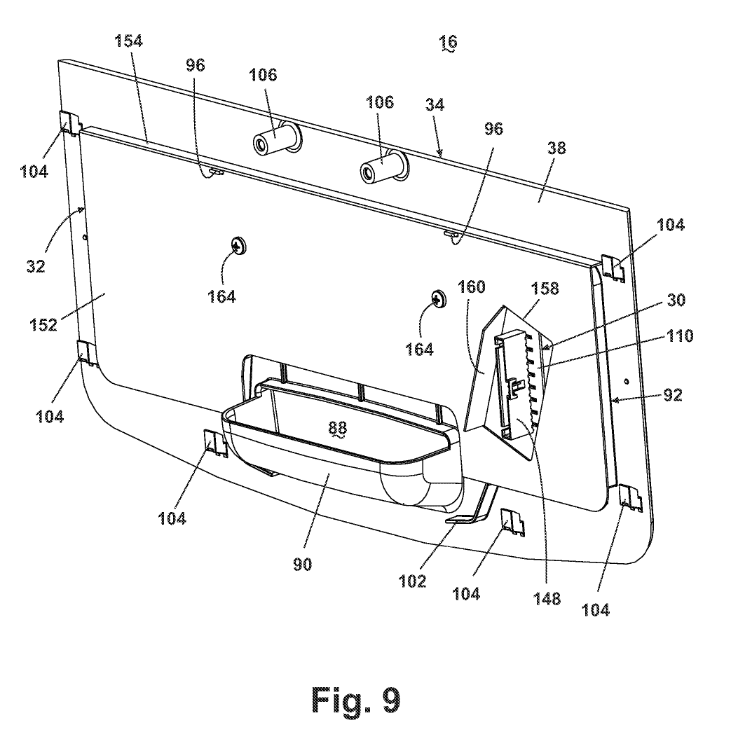

Referring again to FIG. 7, the inner panel 32 can be shaped and sized to cover the support panel 30 when the support panel 30 and the inner panel 32 are mounted to the outer panel 34. The inner panel 32 has a front or outer side 150 (FIG. 4) and a rear or inner side 152 and can include a forwardly extending upper flange 154, a pair of generally horizontal slits 156 sized to receive the lateral tabs 96 of the outer panel 34, and a pair of holes 162. As seen in FIG. 9, which is a rear perspective view of the control panel 16 of FIG. 2, an opening 158 formed in the inner panel 32 accommodates the connector 148 when the inner panel 32 and the support panel 30 are mounted together. A rearwardly extending spacer 160 at the opening 158 helps to maintain a spacing suitable to accommodate the connector 148 between the inner panel 32 and the dishwasher 18 when the control panel 16 is mounted to the dishwasher 18.

To assemble the control panel 16, the support panel 30 can be positioned within the frame defined by the projections 92, 100, 102 with the front side 108 of the support panel 34 facing the rear side 38 of the outer panel 34. In this position, the slits 112 receive the depending tabs 98, and the sensors 122, 132, 134 and the indicators 128, 130, 140, 142, 144, 146 are in register with the corresponding structures of the outer panel 34. In particular, the sensors 122 of the sensor array 120 are in register with the channel 42, the sensor 132 is in register with the depression 58, the first set 136 of the sensors 134 are in register with the first set 70 of the depressions 68, and the second set 138 of the sensors 134 are in register with the second set 72 of the depressions 68. Further, the indicators 128 are in register with the apertures 66, the indicator 130 is in register with the aperture 57, the indicators 140 are in register with the apertures 80, the indicators 142 are in register with the apertures 82, the indicator 144 is in register with the aperture 84, and the indicators 146 are in register with the apertures 86. When the sensors 122, 132, 134 are in register with the corresponding channel 42 or depressions 68, the sensors 122, 132, 134 are positioned relative to the corresponding channel 42 or depressions 68 so that the sensors 122, 132, 134 can sense the presence of a finger in the vicinity of the corresponding channel 42 or depression 68. Thus, the sensors 122, 132, 134 are not required to be, but can be, positioned directly behind the corresponding channel 42 or depressions 68. When the indicators 128, 130, 140, 142, 144, 146 are in register with the corresponding apertures 66, 57, 80, 82, 84, 86, the indicators 128, 130, 140, 142, 144, 146 are positioned to communicate a signal, such as a light, through the corresponding apertures 66, 57, 80, 82, 84, 86 so that the signal is discernable by a user. Thus, the indicators 128, 130, 140, 142, 144, 146 are not required to be, but can be, positioned directly behind the corresponding apertures 66, 57, 80, 82, 84, 86.

To continue with the assembly, the inner panel 32 is positioned over the support panel 30 with the flange 154 resting on the horizontal portion 94 of the U-shaped projection 92, the slits 156 receiving the lateral tabs 96, the connector 148 extending through the opening 158, and the holes 162 aligned with the screw bosses 114. Screws 164 or other suitable mechanical fasteners are inserted through the holes 162 and mate with the screw bosses 114 to secure the inner panel 32 to the support panel 30. Alternatively, the inner panel 32 can be secured to the support panel 30 prior to mounting the support panel 30 to the outer panel 34. The assembled control panel 16 can be mounted to the dishwasher 18 via the mounting tabs 104 and mechanical fasteners that mate with the screw bosses 106.

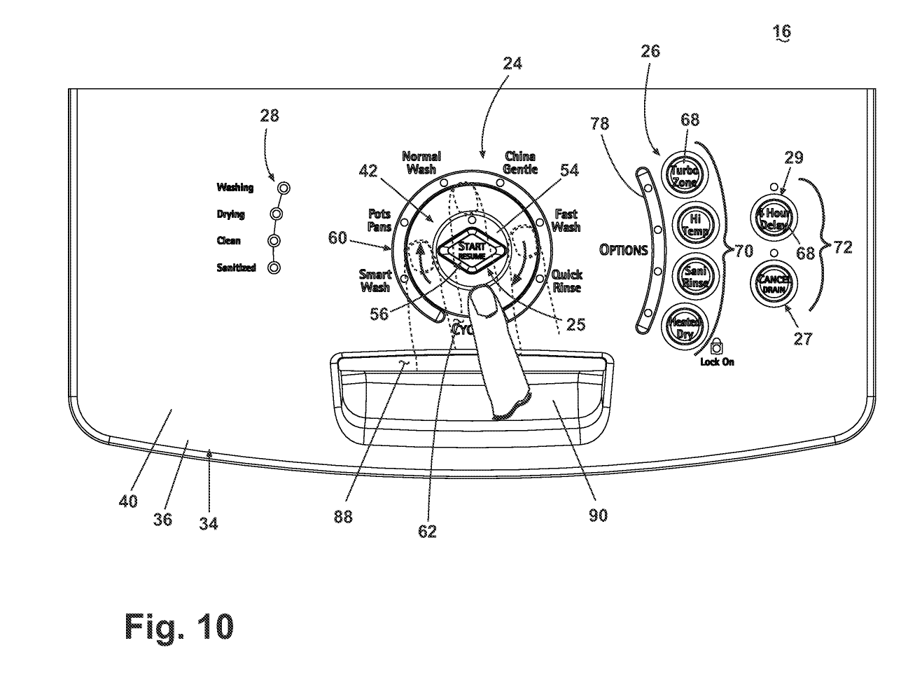

An exemplary operation of the dishwasher 18 with the embodiment of the control panel 16 shown in FIGS. 2-9 is described below with respect to FIG. 10, which is a front view similar to FIG. 3 of the control panel 16, with a finger moving along the channel 42 of the operation mode selector 24. When the user desires to operate the dishwasher 18, the user selects the desired operational mode and options for the selected operational mode through the mode selector 24 and the option selector 26 of the control panel 16. For example, the user positions an appendage, such as a tip of a finger, in the channel 42, as shown in solid lines in FIG. 10. The user can begin, for example, by placing the finger above the gap 62 of the rib 60. In this position, the finger is aligned with the gap 124 in the sensor array 120 (FIG. 7), and, therefore, none of the sensors 122 in the sensor array 120 are activated. The user can move the finger along the channel 42 in either direction (clockwise movement of the finger is indicated in phantom in FIG. 10), and the channel 42 conveniently guides the finger to move along the sensor array 120. Movement of the finger along the channel 42 can be referred to as slewing, especially when the channel 42 is configured as a circle. The slewing movement of the finger along the channel 42 is an intuitive movement for the user and thereby improves the ease of use of the control panel 16. As the finger moves along the channel 42, the finger selectively activates the sensors 122 of the sensor array 120 (FIG. 7), and the sensors 122 detect the position of the finger. When the finger activates one of the sensors 122 to select the corresponding operational mode, the indicator 128 (FIG. 7) corresponding to the selected operational mode illuminates or otherwise communicates to the user the selected operational mode. Conversely, when the finger deselect the operational modes by removing the finger from the vicinity of the sensors 122 or not placing the finger in the vicinity of the sensors 122, the indicators 128 corresponding to the deselected operational modes de-illuminate or otherwise communicate to the user that the corresponding operational modes are not selected.

For example, when the finger is positioned in the channel 42 proximate the sensor 122A, the sensor 122A detects the presence of the finger and sends a signal to the controller 12 to indicate that the operational mode corresponding to the sensor 122A, e.g. the Smart Wash operational mode, is the selected operational mode. The indicator 128A corresponding to the sensor 122A illuminates or otherwise communicates to the user that the selected operational mode is the operational mode corresponding to the sensor 122A. According to the illustrated embodiment, the indicator 128A communicates to the user that the Smart Wash mode is the selected operational mode. Continued movement of the finger along the channel 42 progressively and individually activates the sensors 122A-122F, and the corresponding indicator 128A-128F progressively and individually illuminates or otherwise communicates to the user the selected operational mode. As the sensors 122A-122F are selectively activated, they send a signal to the controller 12 to indicate that the operational mode corresponding to the respective sensor 122A-122F is the selected operational mode. When the user's finger has activated the sensor 122 corresponding to the desired operational mode, the user removes the finger from the channel 42. Alternatively, the user can touch the channel 42 in an area corresponding to the desired operational mode rather than slewing the finger along the channel 42. According to the current embodiment, when one of the operational modes is selected, the other operational modes are deselected. In other embodiments, multiple operational modes can concurrently be selected.

When an operational mode having options is selected, the corresponding options can be automatically selected by the controller 12, and the indicators 140 (FIG. 7) for those options are illuminated or otherwise communicate to the user the selected options. If the user does not desire to utilize the selected options, the user can position an appendage, such as the tip of the finger, in the appropriate depression 68 to activate the corresponding sensor 134 (FIG. 7) and thereby deselect the corresponding option. The activated sensor 134 sends a signal to the controller 12 indicating that the option is not desired, and the corresponding indicator 140 (FIG. 7) de-illuminates, changes color, or otherwise communicates to the user that the option has been deselected. If the user accidentally deselects an option or decides that the deselected option is indeed desired, then the user can select the option by simply placing the finger in the corresponding depression 68.

When the desired operational mode and options are selected, the user can begin the selected operational mode through the mode activation selector 25. In particular, the user positions an appendage, such as the tip of the finger, in the center area depression 56 to activate the sensor 132 (FIG. 7). In response, the sensor 132 sends a signal to the controller 12 to begin the selected operational mode, and the indicator 130 (FIG. 7) illuminates or otherwise communicates to the user that the selected operational mode has begun.

If, at any time during the running of the operational mode, the user decides to stop or interrupt the running of the operational mode, then the user positions an appendage, such as the tip of the finger, in the depression 68 corresponding to the mode cancellation selector 27 to activate the corresponding sensor 134 (FIG. 7), which sends a signal to the controller 12 to cease the running of the selected operational mode, and the appropriate indicator 142 (FIG. 7) illuminates or otherwise communicates to the user that the selected operational mode has been stopped. At the same time, the indicator 130 (FIG. 7) de-illuminates, changes color, or otherwise communicates to the user that the selected operational mode is no longer running. The user can resume the selected operational mode through the mode activation selector 25 as described above.

If the user desires to delay the running of the selected operational mode prior to starting the selected operational mode through the mode activation selector 25, the user positions an appendage, such as the tip of the finger, in the depression 68 corresponding to the mode delay selector 29 to activate the corresponding sensor 134 (FIG. 7), which sends a signal to the controller 12 to delay the running of the selected operational mode, and the appropriate indicator 142 (FIG. 7) illuminates or otherwise communicates to the user that the selected operational mode will be delayed. The delay time begins when the user activates the selected operational mode through the mode activation selector 25 as described above.

While the selected operational mode is running, the mode status indicator 28 communicates to the user the operational status of the operational mode. In particular, the indicators 146 (FIG. 7) illuminate or otherwise communicate to the user the particular stage of the operational mode as described above.

It is within the scope of the invention to modify the control panel 16 shown in the figures and described above. For example, the channel 42 can have any suitable configuration in addition to the circular configuration. For example, the channel 42 can be a curved or straight line, a zigzag, a horseshoe shape, a rectangle, an oval, or any other geometric shape. Further, the sensor array 120 can have any suitable configuration that corresponds to the configuration of the channel 42. Additionally, various features of the outer panel 34 have been described as recessed, such as the channel 42, or raised, such as the rib 60, relative to the nominal surface; however, the recessed features can be raised relative to the nominal surface and vice-versa. Furthermore, the features can be flush with the nominal surface. Additionally, all of the features do not have to be employed together. For example, the channel 42 can be utilized without the raised center area 54 and/or the depression 56 in the center area 54. Further, the nominal surface can be planar, as shown in the figures, or can have another profile, such as a curved surface, that serves as a reference for the recessed and raised features. The indicators can have any suitable form and need not be associated with a raised rib. For example, the indicators can be an illumination source that backlights text of the names of the operational modes on the outer panel 34 when the corresponding sensor 122, 132, 134 is activated. Alternatively, the indicators can be an illumination source aligned with the channel 42 to illuminate a portion of the channel 42 beneath the finger as the finger moves along the channel 42. The sensors 122, 132, 134 are shown as being supported on the rear side 110 of the support panel 30; however, the sensors 122, 132, 134 can be supported on the front side 108 of the support panel 30 if desired. Additionally, the option selector 26 can be designed so that the options are not automatically selected but manually selected. For example, the indicators 140 corresponding to the options available for the selected operation mode can illuminate or otherwise activate to communicate to the user the available options, and the user positions the finger on the depression 68 corresponding to a desired option to select the option.

While the mode selector 24 of the embodiment shown in FIGS. 2-10 has been described with respect to selecting the operational mode of the dishwasher 18, it is to be understood that the mode selector 24 can be configured to select any user input for any type of electronic device. For example, the mode selector 24 can be used for volume control of an audio device, temperature control of a thermostat, and number selection of a keypad, such as for a telephone.

Various features of the outer panel 34 have been described as being recessed (e.g., the channel 42 and the depressions 68) or raised (e.g., the rib 60 and the rib 78) relative to the nominal surface 40. As stated above, the nominal surface 40 can be coincident with the front side 36 of the outer panel 34 or higher or lower than the front side 36. In the embodiment shown in FIGS. 2-10, the nominal surface 40 is shown as coincident with the front side 36 with the channel 42 being recessed relative to the front side 36.

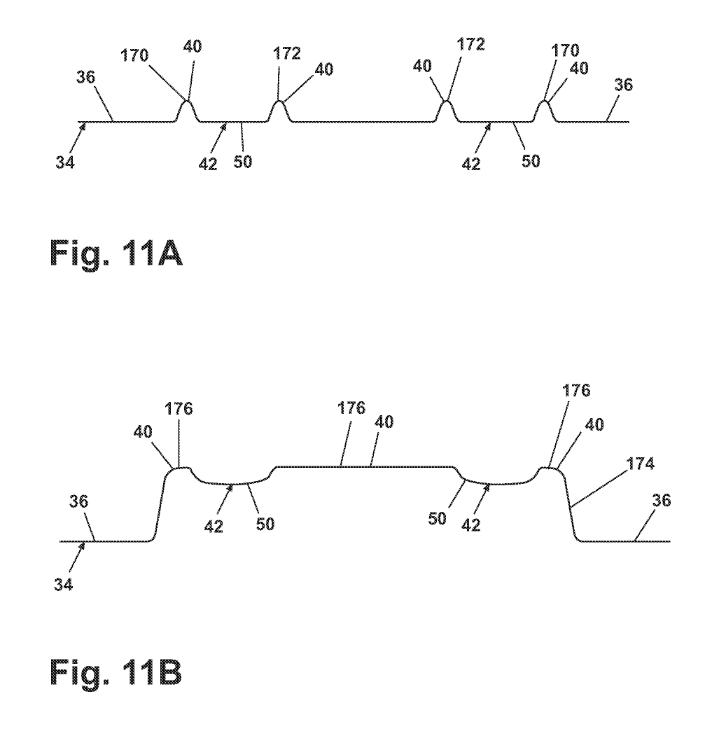

FIG. 11A is a view similar to FIG. 8B of a control panel 16 according to a second embodiment of the invention. In the second embodiment, a pair of concentric ribs 170, 172 defines an outer and inner periphery for the channel 42 and defines the nominal surface 40, which is higher than the front side 36. The bottom 50 of the channel 42 is shown as being oriented generally coplanar with the front side 36 of the outer panel 34; alternatively, the bottom 50 can be higher or lower than the front side 36. Although not shown, the second embodiment can include a center area similar to the center area 54 of the first embodiment control panel 16.

FIG. 11B is a view similar to FIG. 8B of a control panel 16 according to a third embodiment of the invention. In the third embodiment, the control panel 16 includes a raised portion 174 with an upper surface 176 raised relative to the front side 36 of the outer panel 34. The upper surface 176 defines the nominal surface 40 with the channel 42 recessed relative to the upper surface 176. The bottom 50 of the channel 42 is shown as raised relative to the front side 36 of the outer panel 34; alternatively, the bottom 50 can be coplanar with or lower than the front side 36. Although not shown, the third embodiment can include a center area similar to the center area 54 of the first embodiment control panel 16.

While the invention has been specifically described in connection with certain specific embodiments thereof, it is to be understood that this is by way of illustration and not of limitation, and the scope of the appended claims should be construed as broadly as the prior art will permit.

1. A control panel for an electronic device, the control panel comprising:
a support panel;
a sensor array on the support panel and operable to sense a location along the sensor array of a finger proximate to the sensor array;
an outer panel covering the support panel and having a nominal surface; and
a channel formed in the outer panel with at least a portion of the channel located below the nominal surface, the channel defining a guide path sized to receive a portion of a finger and in register with at least a portion of the sensor array; whereby the channel is configured to guide a finger of a user along the sensor array, and the sensed location of the finger along the sensor array is used as an indication of an input selection by the user.

2. The control panel according to claim 1 wherein the entire channel is located below the nominal surface.

3. The control panel according to claim 1 wherein the channel comprises a bottom located below the nominal surface.

4. The control panel according to claim 3 wherein the channel has a width in a range of about 10 mm to about 15 mm.

5. The control panel according to claim 4 wherein the width of the channel is between about 11 and 12 mm.

6. The control panel according to claim 4 wherein the bottom is about 1 mm below the nominal surface.

7. The control panel according to claim 3 wherein the channel further comprises an open top substantially flush with the nominal surface.

8. The control panel according to claim 3 wherein the channel has at least one of an arcuate, straight, zigzag, horseshoe, oval, and rectangular configuration.

9. The control panel according to claim 8 wherein the channel comprises an inner edge that defines a center area raised relative to the bottom of the channel.

10. The control panel according to claim 9 wherein the center area comprises a top flush with the nominal surface.

11. The control panel according to claim 9, further comprising a switch on the support panel in register with the center area.

12. The control panel according to claim 10 wherein the center area comprises a depression in register with the switch, and the depression comprises a bottom substantially flush with the bottom of the channel.

13. The control panel according to claim 1 wherein the sensor array has at least one of an arcuate, straight, zigzag, horseshoe, oval, and rectangular configuration.

14. The control panel according to claim 1 wherein the sensor array comprises multiple portions, and each portion corresponds to one input selection.

15. The control panel according to claim 14 wherein at least one of the portions comprises a single discrete sensor.

16. The control panel according to claim 1, further comprising indicators located adjacent the channel and operably coupled with the sensor array to communicate to the user the input selection corresponding to the sensed location of the finger along the sensor array.

17. The control panel according to claim 16 wherein the indicators comprise an illumination source.

18. The control panel according to claim 16 wherein the outer panel comprises a rib adjacent the channel, and the indicators are associated with the rib.

19. The control panel according to claim 18 wherein the rib is raised above the nominal surface.

20. The control panel according to claim 1, further comprising at least one switch coupled with the support panel and at least one depression formed in the outer panel and spaced from the channel in register with the at least one switch.

21. The control panel according to claim 20 wherein actuation of the at least one switch by a finger proximate to the at least one depression is used as an indication of one of a selection and deselection by the user of at least one option for the input selection.

22. The control panel according to claim 21, further comprising at least one indicator located adjacent the at least one depression and operably coupled with the at least one switch to communicate to the user the at least one selected or deselected option for the input selection.

23. The control panel according to claim 22 wherein the at least one indicator comprises an illumination source.

24. The control panel according to claim 23 wherein the at least one illumination source illuminates in response to the sensed location of the finger along the sensor array.

25. The control panel according to claim 1 wherein the electronic device is a household appliance comprising a controller for implementing a mode of operation of the appliance and operably coupled with the sensor array, wherein the sensor array is operable to communicate to the controller the mode of operation as indicated by the location of the finger along the sensor array.

26. The household appliance according to claim 25 wherein the household appliance is a dishwasher.

27. A control panel for an electronic device, the control panel comprising:
a sensor array operable to sense a location along the sensor array of a finger proximate to the sensor array;
a guide path in register with at least a portion of the sensor array and sized to receive a portion of a finger, the guide path operable to guide a finger of a user along the sensor array, and the sensed location of the finger along the sensor array is used as an indication of a selection by the user; and
a plurality of indicators associated with the guide path and operably coupled with the sensor array to communicate to the user the selection corresponding to the sensed location of the finger along the sensor array.

28. The control panel according to claim 27, further comprising an outer panel having a nominal surface, and the guide path is formed in the outer panel with at least a portion of the guide path located below the nominal surface.

29. The control panel according to claim 42 wherein the sensor array and the guide path have at least one of an arcuate, straight, zigzag, horseshoe, oval, and rectangular configuration.

30. The control panel according to claim 27 wherein the guide path comprises an inner edge that defines a center area that is raised relative to the guide path.

31. The control panel according to claim 30, further comprising a switch in register with the center area.

32. The control panel according to claim 27 wherein the guide path and the sensor array collectively form an input selector, and the selection by the user is an input selection.

33. The control panel according to claim 32 wherein the plurality of indicators are located adjacent to the guide path.

34. A control panel for an electronic device, the control panel comprising:
a panel having a guide path with a width of about 10 mm to about 15 mm and a depth of about 0.1 mm to about 3 mm and operable to receive a finger;
one of a plurality of sensors and a sensor array operable to sense the location of a finger received by the guide path; and
a plurality of indicators associated with the guide path and operable to provide a visual indication corresponding to the location of a finger relative to the one of the plurality of sensors and the sensor array.

35. The control panel according to claim 34 wherein the indicators are located adjacent to the guide path.

36. The control panel according to claim 34 wherein the guide path is at least partially recessed below an outer face of the panel.

37. The control panel according to claim 34 wherein the guide path is coplanar with an outer face of the panel, and a rib forms an outer periphery for the guide path.

38. The control panel according to claim 34 wherein the guide path is formed in a portion of the panel that is raised relative to an outer face of the panel.

39. The control panel according to claim 16 wherein the channel defines an outer periphery and the indicators are located along the outer periphery.

40. The control panel according to claim 39 wherein the indicators circumscribe at least a portion of the outer periphery.

41. The control panel according to claim 16 wherein each indicator corresponds to a distinct function of the electronic device and indicates the selected function.

42. The control panel according to claim 1, wherein the channel defines an outer periphery and further comprising indicators located along the outer periphery and operably coupled with the sensor array to communicate to the user the input selection corresponding to the sensed location of the finger along the sensor array.

43. The control panel according to claim 42 wherein the indicators circumscribe at least a portion of the outer periphery.

44. The control panel according to claim 27 wherein each indicator corresponds to a distinct function of the electronic device.

45. A control panel for an electronic device, the control panel comprising:
a sensor array operable to sense a location along the sensor array of a finger proximate to the sensor array;
a guide path in register with at least a portion of the sensor array and sized to receive a portion of a finger, the guide path operable to guide a finger of a user along the sensor array, and the sensed location of the finger along the sensor array is used as an indication of a selection by the user; and
a plurality of indicators located adjacent the guide path and operably coupled with the sensor array to communicate to the user the selection corresponding to the sensed location of the finger along the sensor array.
